(19) United States
(12) Patent Application Publication
(10) Pub. No.: US 2007/0127461 A1
(43) Pub. Date: Jun. 7, 2007

(54) Router and communication system

(75) Inventors: Mariko Yamada, Tokyo (JP); Masahide Nakamura, Fujisawa (JP)

Correspondence Address: Stanley P. Fisher;Reed Smith LLP, Suite 1400, 3110 Fairview Park Drive, Falls Church, VA, 22042-4503, US

(73) Assignee: Hitachi Communication Technologies, Ltd.

(21) Appl. No.: 11/492,181

(22) Filed: Jul. 25, 2006

(30) Foreign Application Priority Data
Dec. 7, 2005 (JP) 2005-352842

(51) Int. Cl. H04L 12/56; H04L 12/28

(52) U.S. Cl. 370/389; 370/395.53

(57) ABSTRACT

When points are connected by a L2VPN, it is necessary to unify the address system (network). When the user sets the address manually, address duplication may occur or the network may not be unified due to a setting mistake. In addition, when points are connected by a L2VPN, the VPN internet connection is redundant, and therefore must be prevented. The delegate CE router from among the CE routers that make up the VPN determines the address that is distributed by the other CE routers on the LAN. The determined address is included in the control message for establishing the VPN and the address is then distributed to the other CE routers. Also, the control message for establishing the VPN includes the interface MAC address that is used by the CE routers on the LAN. Each CE router controls the channel according to the MAC address of the next-hop router.

### CLAIM OF PRIORITY

The present application claims priority from Japanese application JP 2005-352842 filed on Dec. 7, 2005, the content of which is hereby incorporated by reference into this application.

### Field of the Invention

The present invention relates generally to a communication system that configures Virtual Private Networks (VPN) between physically distant locations using Internet Protocol.

### BACKGROUND OF THE INVENTION

EtherIP (RFC3378) and L2TPv3 (RFC3931) have been standardized by the IETF as the configuration method for L2VPNs that use Internet Protocol (IP). With EtherIP, VPN equipment acquires an ether frame that flows on a LAN connected with VPN equipment, and the ether frame, which is encapsulated by the EtherIP header and the IP header, is sent to the VPN equipment at the other end. The VPN equipment that receives the IP packet that contains the ether frame encapsulated by the EtherIP header and the IP header removes the ether frame from the received IP packet and sends the ether frame on the LAN connected to the VPN equipment, which received the IP packet. This is done in order to configure the L2VPN. Two logical channels (control channel and data channel) are defined in L2TPv3. The control channel establishes and releases the control connection and session. The data channel transfers the ether frame using the established session. The L2TP session header is used to transfer the ether frame. The session header is encapsulated by the IP header, UDP header, or IP header.

### SUMMARY OF THE INVENTION

When Local Area Networks (LAN) are connected through a L2VPN, it is possible to share the broadcast domains between the connected LANs. Therefore, by using ARP (Address Resolution Protocol) and NDP (Neighbor Discovery Protocol), MAC address resolution can be executed for the other communicating party's terminal, and direct communication is possible in the second layer (Layer2: L2) for the OSI (Open System Interconnection) reference model. The range of the MAC address resolution using ARP and NDP is only within the same network. Therefore, it is necessary to unify the address system (network) between the connected LANs. Usually, users set up the addresses manually or aggregate the DHCP (Dynamic Host Configuration Protocol) servers at one location. When the user sets up the address manually, address duplication and network disunity may occur due to a setting mistake. As a result, communication may be impossible. Also, when the DHCP server is aggregated at one location, if the VPN is not established and the terminal at the location with no DHCP server requests the IP address, the request for the IP address will not be sent to the DHCP server, so the IP address cannot be acquired. The request for the IP address may be made by a terminal whenever it is needed, so it is necessary to always have the VPN established.

When the LAN terminal and the CE (Customer Edge) router, which provides the communication channel for the internet terminal, are connected through a L2VPN, and the address system (network) is uniform, the LAN interface of the CE router exists in the same network from the viewpoint of both LANs that are connected by the VPN. Therefore, it is possible to resolve the MAC address of the CE router using ARP or NDP to have direct communication at L2. Also, when either one of the routers that are connected by the VPN is selected as the next-hop router, it is possible to communicate with the internet terminal. However, connecting to the internet through the CE router, which is connected through the VPN, is redundant, so it is necessary to prevent this redundant communication channel.

The delegate CE router from the CE routers that make up the VPN determines the address that will be distributed by the other CE routers over the LAN. The determined address will be included in the control message when the VPN is being established and will be distributed to the CE router. In addition, the control message when the VPN is being established includes the MAC address of the interface used by the other CE routers over the LAN. Each CE router executes path control based on the MAC address of the next-hop CE router.

With the present invention, it is possible to prevent disunity of the address system and prevent address duplication. Also, it is possible to prevent long paths when terminals on the L2VPN communicate with internet terminals.

### BRIEF DESCRIPTION OF THE DRAWINGS

FIG. 1 is a sequence drawing illustrating the implementation of the present invention;

FIG. 2 is a schematic diagram illustrating the communication system implementing the present invention;

FIG. 3A is a schematic diagram illustrating the internal configuration of the CE router that is used for the present invention;

FIG. 3B is a schematic diagram illustrating the internal program of the CE router that is used for the present invention;

FIG. 4A is a schematic diagram illustrating the distribution address management table;

FIG. 4B is a schematic diagram illustrating the connected CE router management table;

FIG. 4C is a schematic diagram illustrating the delegate router address pool table;

FIG. 5A is a schematic diagram illustrating the router information management table;

FIG. 5B is a schematic diagram illustrating the group IP address management table;

FIG. SC is a schematic diagram illustrating the connected CE router program management table;

FIG. 6A is a schematic diagram illustrating the router MAC address AVP;

FIG. 6B is a schematic diagram illustrating the router type AVP;

FIG. 6C is a schematic diagram illustrating the request address number AVP;

FIG. 7A is a schematic diagram illustrating the distribution address range AVP;

FIG. 7B is a schematic diagram illustrating the distribution address AVP;

FIG. 8 is a flow chart illustrating the control connection setup program of the delegate CE router;

FIG. 9 is a flow chart illustrating the control connection setup program for non-delegate CE routers;

FIG. 10A is a flow chart illustrating the VPN transport program of the sender;

FIG. 10B is a flow chart illustrating the VPN transport program of the receiver;

FIG. 11 is a sequence drawing illustrating how the delegate CE router promotes the control connection setup program;

FIG. 12 is a schematic diagram illustrating how the present invention is implemented in a communication system where only one CE router connects with the ISP network;

FIG. 13 is a schematic diagram illustrating how the present invention is implemented in a communication system with a VPN control server;

FIG. 14 is a sequence drawing illustrating how the present invention is implemented using a VPN control server;

FIG. 15 is a schematic diagram illustrating how the present invention is implemented in a communication system where a VPN is provided through an ISP network; and

FIG. 16 is a schematic diagram illustrating how the present invention is implemented in a communication system where a VPN is provided through a carrier and ISP network.

### DETAILED DESCRIPTION OF THE PREFERRED EMBODIMENTS

### First Embodiment

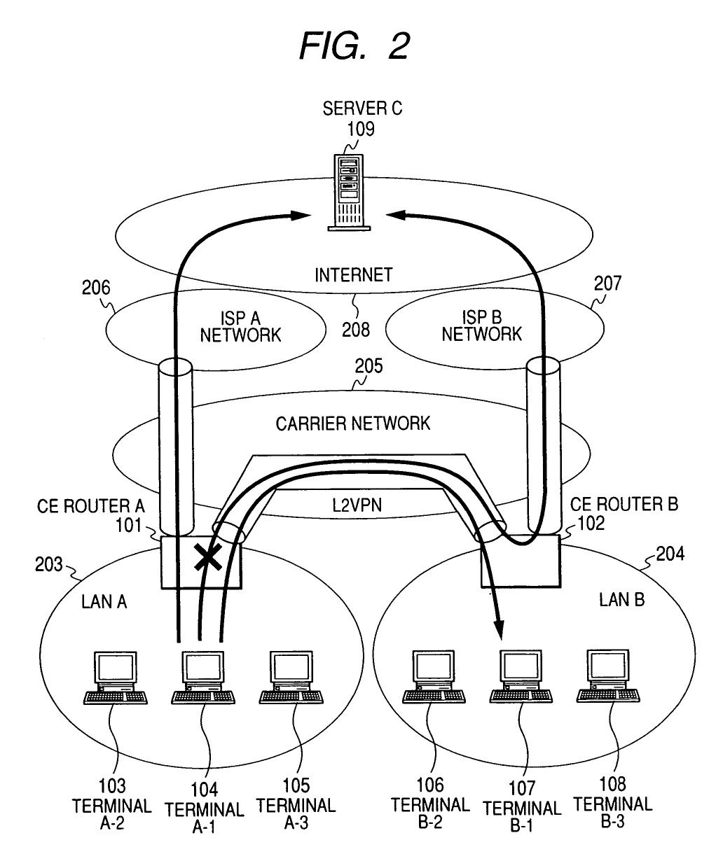

FIG. 2 illustrates a communication system implementing the present invention. The communication system consists of CE router A 101, CE router B 102, LAN A 203 which contains CE router A, LAN B 204 which contains CE router B, a carrier network 205, ISP A network 206, ISP B network 207, internet 208, terminals A-1 104, A-2 103, and A-3 105 which are connected with LAN A, terminal B-1 107, B-2 106, and B-3 108 which are connected with LAN B, and server C 109 which is connected with the internet. CE router A 101 and CE router B 102, the carrier network 205, ISP networks A 206, ISP network B 207, and the internet 208 are connected using internet protocol.

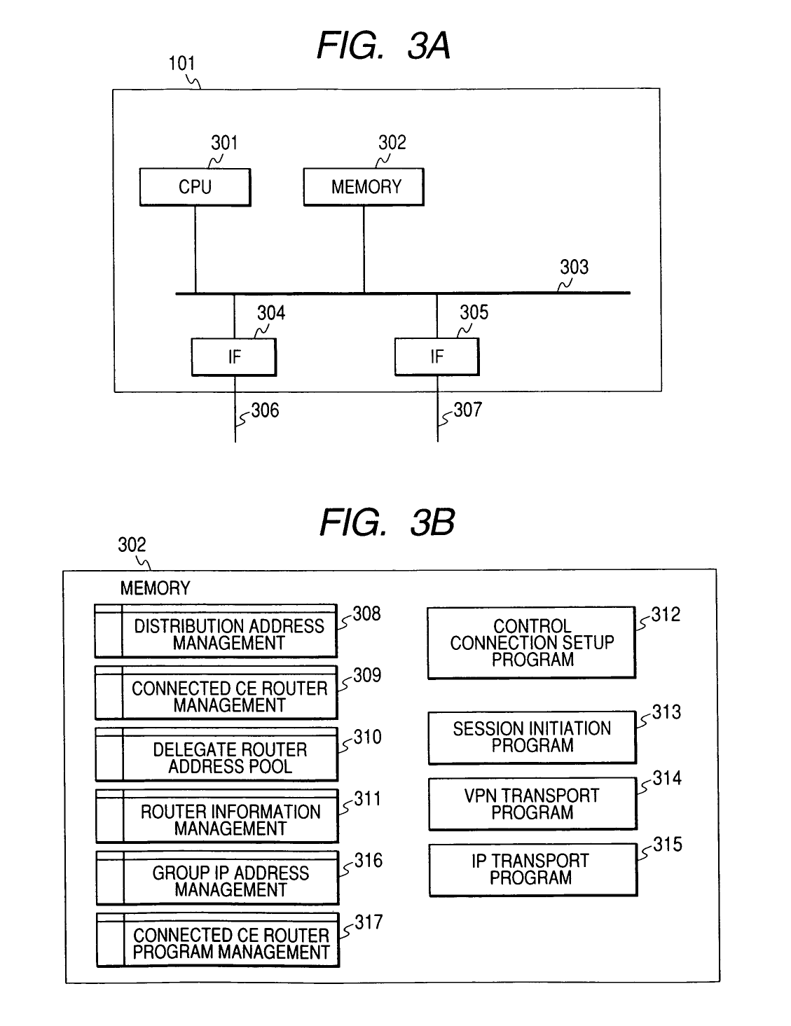

FIG. 3A illustrates the configuration of the CE routers. CE router A 101 consists of a CPU (Central Processing Unit) 301, memory 302, and interface portions 304 and 305. The CPU 301 executes application programs and the OS (Operating System). The memory 302 stores the programs that are used for executing the CPU 301 and stores various application programs. The CPU 301 and the memory 302 are connected through a bus 303. The interface portions 304 and 305 provide data from the CPU 301 and the memory 302 to external equipment, and also receive data from external equipment. The interface portions are connected to both lines 306 and 307. One of the interface portions 304 or 305 is connected to LAN A 203 and the other is connected to the carrier network 205.

FIG. 3B shows the information that is stored in the memory 302. The memory 302 stores tables including the distribution address management table 308, the connected CE router management table 309, the delegate router address pool table 310, the router information management table 311, the group IP address management table 316, and the connected CE router program management table 317. It also stores programs including the control connection setup program 312, the session initiation program 313, the VPN transport program 314, and the IP transport program 315.

The control connection setup program 312 establishes and releases control connections between CE routers. The session initiation program 313 establishes and releases sessions between CE routers. The VPN transport program 314 transfers the ether frame that is acquired at a location and transfers the ether frame that has been transferred from another location to the LAN. The IP transport program 315 receives the ether frame from the destination MAC address and transfers it according to the IP routing.

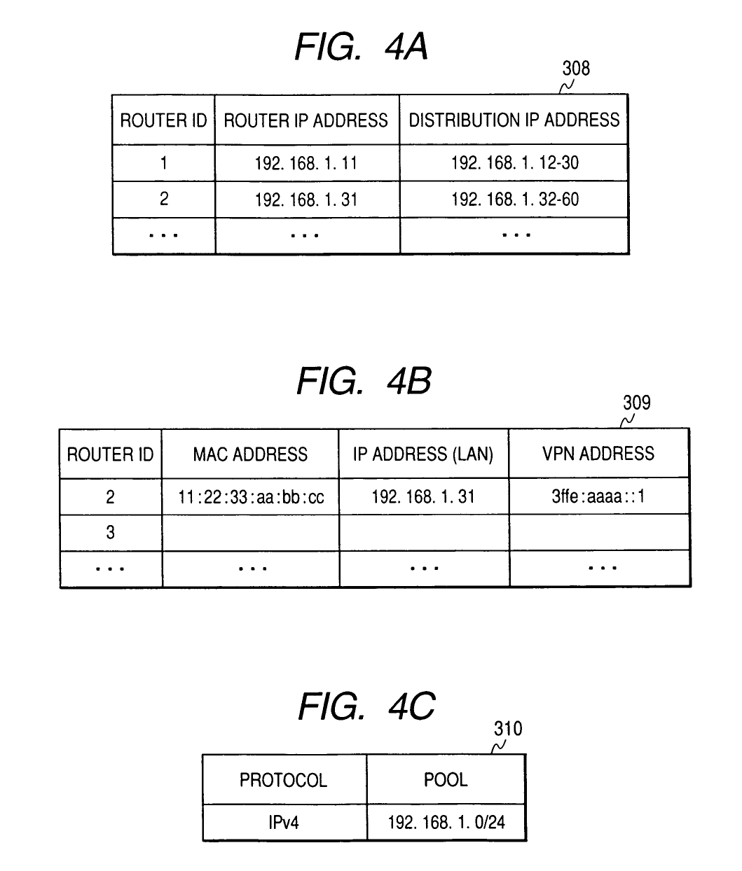

FIG. 4A illustrates the configuration of the distribution address management table 308. This table manages the distribution addresses that are assigned to each CE router on the LAN. The router ID, router IP address, and IP address that are distributed over the LAN need to be managed in order to specify the CE router.

FIG. 4B illustrates the configuration of the connected CE router management table 309. The connected CE router management table manages the information of the next-hop CE router that is connected by the VPN. CE router information includes the router ID, MAC address on the LAN, IP address on the LAN, and the IP address that establishes the VPN.

FIG. 4C illustrates the configuration of the delegate router address pool table 310. This table shows the possible distribution range of the IP address, which is managed by the delegate router.

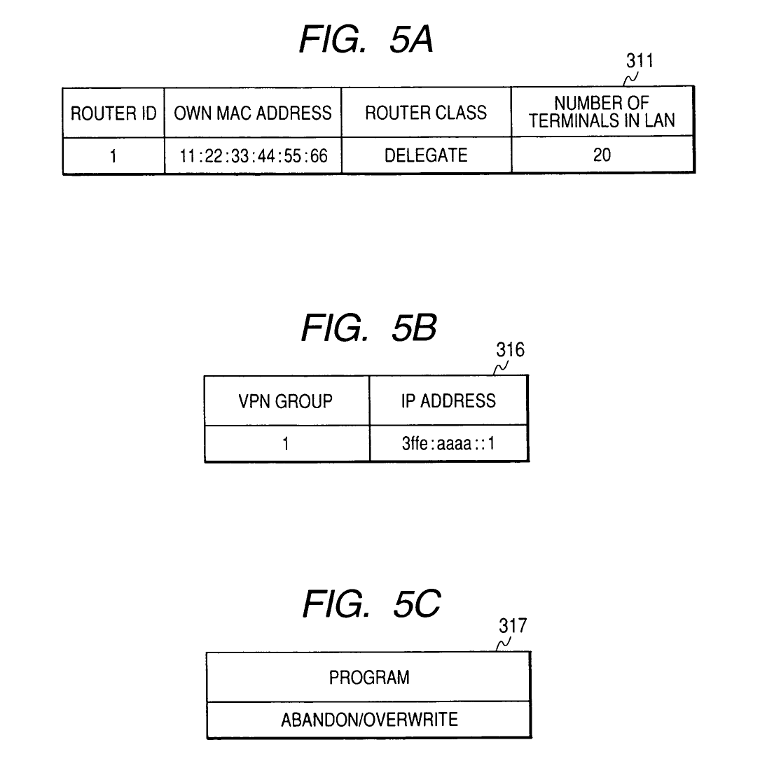

FIG. 5A illustrates the configuration of the router information management table 311. This table manages the information of the own CE router. Own CE router information includes the router ID, own MAC address, router class, and the number of terminals in the LAN. The router class indicates whether it is the own CE router or the delegate CE router. The number of terminals in the LAN shows the maximum number of terminals that can connect with the LAN containing the own CE router.

FIG. 5B illustrates the configuration of the group IP address management table 316. This table manages the IP address of other CE routers that make up the VPN group.

FIG. 5C illustrates the configuration of the connected CE router program management table 317. This table defines how to handle communication through the CE router that is connected with the VPN. If a program is abandoned, communication through the CE router that is connected with the VPN will be abandoned. If the program is overwritten, communication through the CE router that is connected with the VPN will be overwritten.

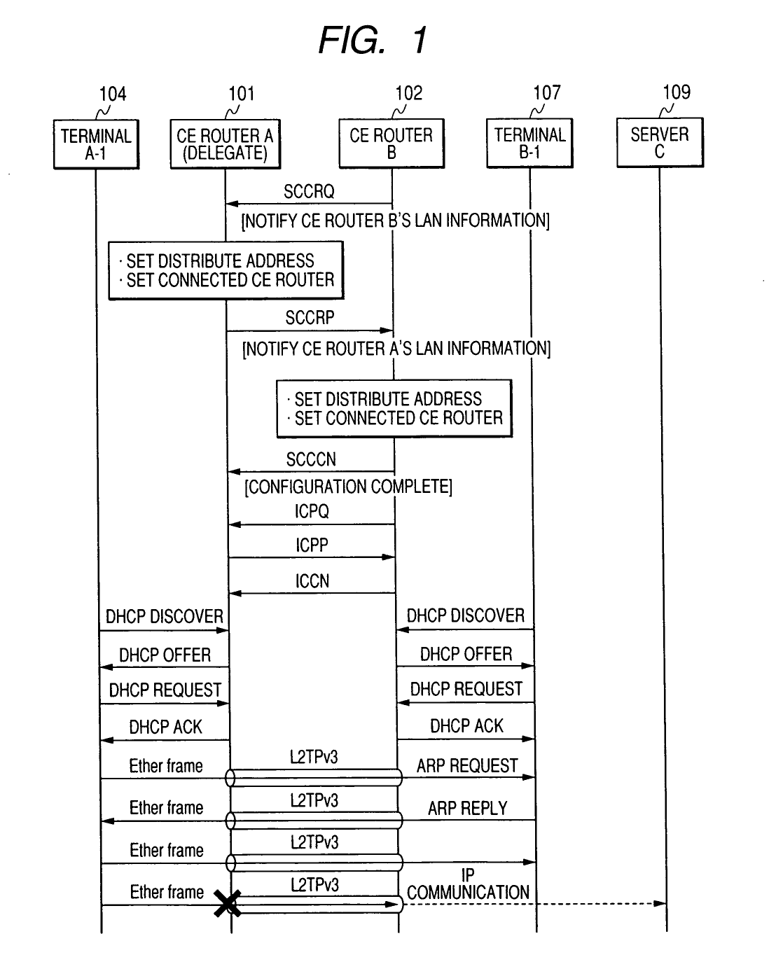

FIG. 1 illustrates the sequence for connecting LAN A 203 and LAN B 204 using the VPN according to the connection control method based on the present invention. According to the embodiment, the group IP address management table 316 is set by the user, and CE router A 101 and CE router B 102 know the IP addresses that can be reached. Also, the router information management table 311 has already been set. CE router A 101 has already set router class for the router information management table 311 as “Delegate.” The router class of CE router B 102 is not set as “Delegate.”

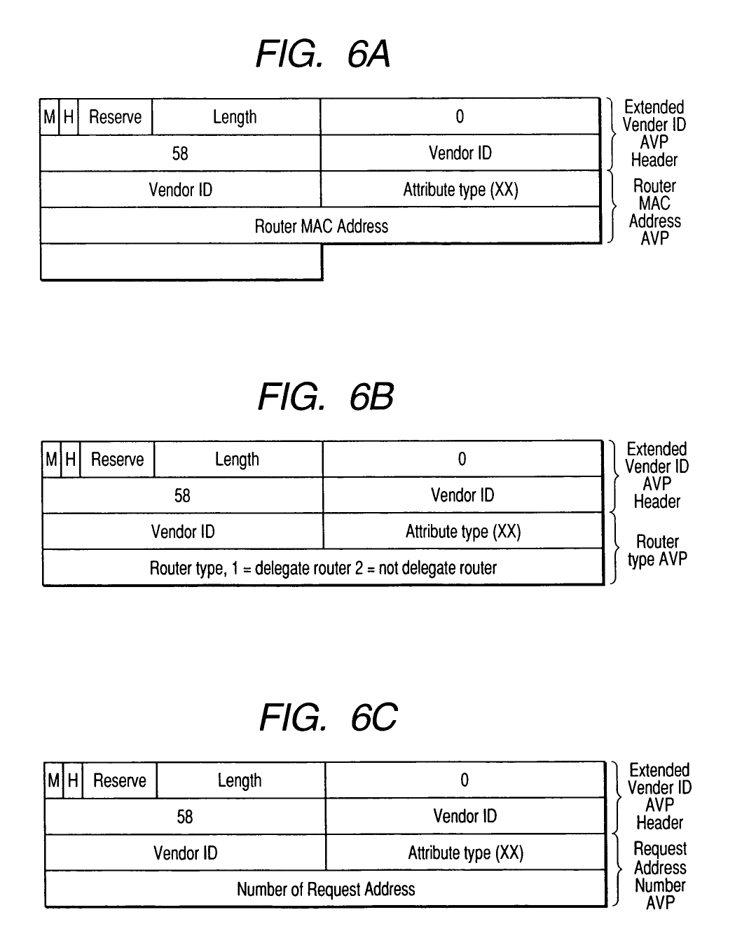

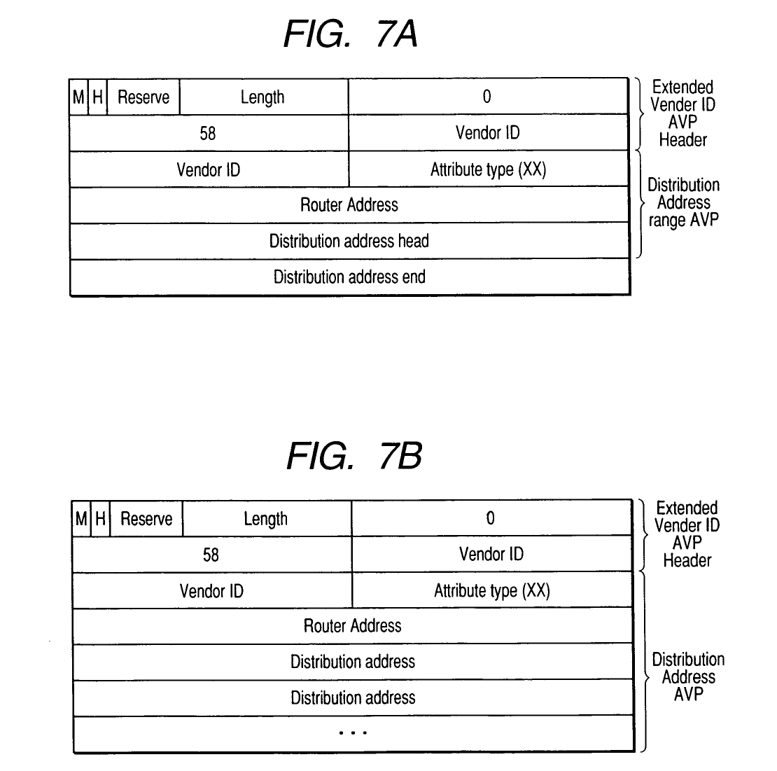

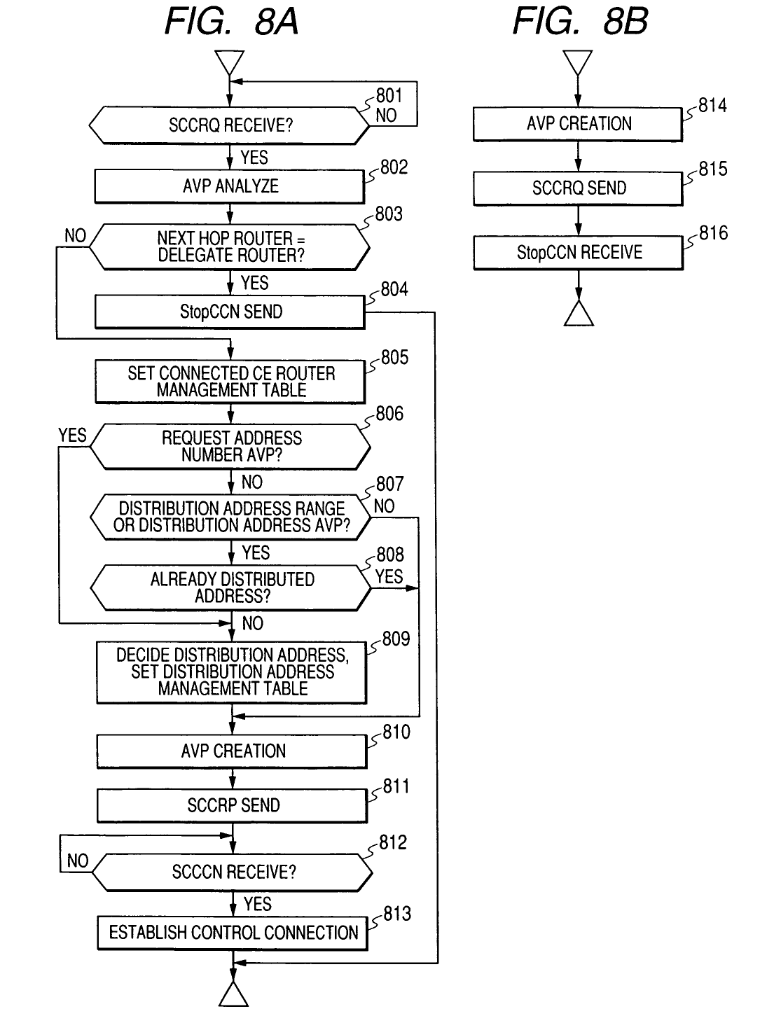

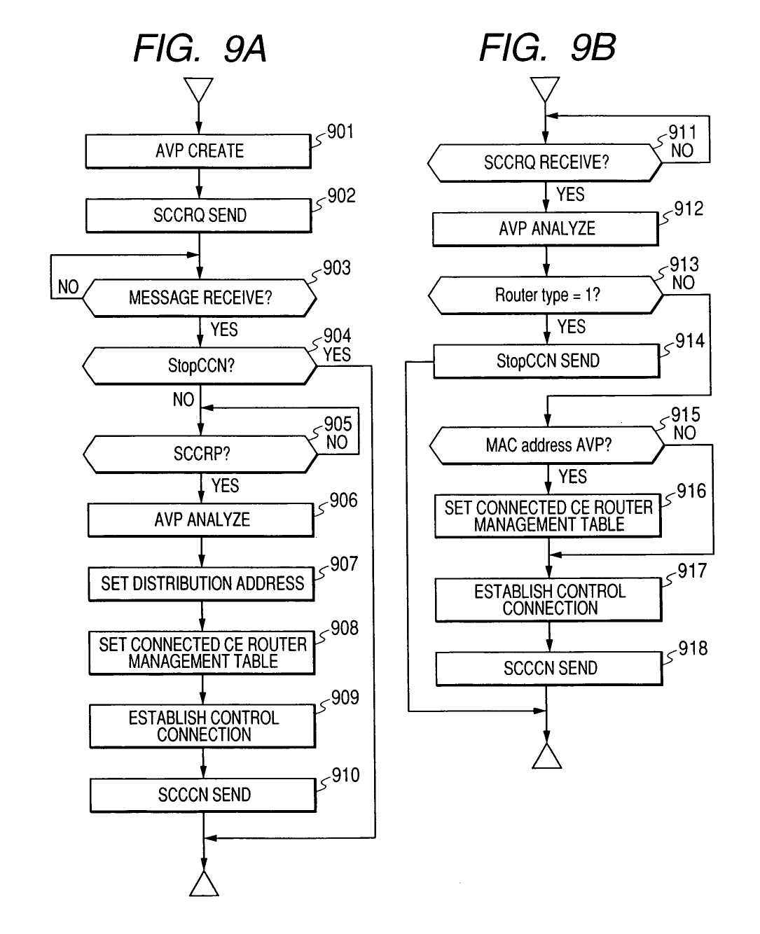

FIG. 8A illustrates the flow of the delegate router for the control connection setup program 312. FIG. 9A illustrates the flow of the control connection setup program 312 for non-delegate routers. CE router B 102 creates an AVP (Attribute Value Pair) in order to establish the control connection (step 901). In addition to the normal AVP when establishing the control connection, the router MAC address AVP, router class AVP, request address number AVP, distribution address AVP, and the distribution address range AVP are created by referencing the router information management table 311. FIG. 6A shows a schematic diagram of the router MAC address AVP. The router MAC address AVP is used for notifying the MAC address of the CE router LAN interface. FIG. 6B shows a schematic diagram of the routerclass AVP. The router class AVP is used for notifying whether a CE router is a delegate router or not. FIG. 6C shows a schematic diagram of the requested address number AVP. The requested address number AVP is used for notifying to the delegate router the number of addresses that need to be assigned. FIG. 7A shows a schematic diagram of the distribution address range AVP. FIG. 7B shows a schematic diagram of the distribution address AVP. The distribution address range AVP and the distribution address AVP are created by referencing the distribution address management table 308. When the distribution IP address is already set in the distribution address management table 308, a distribution address range AVP or a distribution address AVP is created. When the distribution address is already set, it will be shown that the address is already distributed when establishing the previous control connection. When the distribution address is a continuous IP address, the distribution address range AVP will be used. When the distribution address is not a continuous IP address, the distribution address AVP will be used. If a distribution IP address has not been set, a requested address AVP will be created.

CE router B 102 sends a Start-Control-Connection-Request (SCCRQ) message to CE router A 101 (step 902). CE router B 102, which sends the SCCQR message, will remain in standby until it receives a response message (step 903).

CE router A 101 (the delegate router) receives the SCCRQ message (step 801), analyzes the AVP that is given to the SCCRQ (step 802), and acquires the router ID for CE router B 102, the MAC address of the LAN interface for CE router B 102, the router class, the request address number, and the distribution address that is set in the distribution address management table 308 for CE router B 102. The VPN address is the IP address that can reach the next-hop router, which is used for establishing the VPN, and the VPN address is acquired from the source address of the SCCRQ message. This address matches one of the IP addresses set in the group IP address management table 316.

Whether or not the next-hop router is the delegate router is determined by its router class (step 803). If it is the delegate router, Stop-Control-Connection-Notification (StopCCN) is sent (step 804) and the program is terminated. If the next-hop router is not the delegate router, the acquired router ID, MAC address, and the VPN address of CE router B 102 are set in the connection destination CE router management table 309 (step 805).

If the request address number AVP is included, delegate CE router A 101 references the delegate router address pool table 310 and selects addresses according to the number of requested addresses to CE router B 102 from the IP address managed by CE router A 101. From the selected addresses, the address that is set in the CE router B 102 LAN interface and the distribution address will be determined. The determined address is then set in the distribution address management table 308.

If the request address number AVP is not included (step 806) but the distribution address range AVP or the distribution address AVP is included (step 807), the distribution address management table 308 is referenced and it is determined whether the distribution address that is already assigned to CE router B 102 and the distribution address of CE router B 102 that is notified by the distribution address range AVP or the distribution address AVP match (step 808). If they match, the distribution address range AVP or the distribution address AVP, which is notified by CE router B 102 is used when sending the SCCRP. If they do not match, the same program that is used for cases when the request address number AVP is included (step 809) will be executed. If the distribution address range AVP or the distribution address is not included (step 807), the program for the distribution address will not be executed.

CE router A 101 creates the AVP that is given to the Start-Control-Connection-Reply (SCCRP) in order to send the SCCRP message as a response to the SCCRQ. In addition to the AVP for establishing the control connection, a router MAC address AVP, router class AVP, and a distribution address range AVP or distribution address AVP are also created (step 810). The distribution address range AVP and the distribution address AVP are created by referencing the distribution address management table 308. The distribution address range AVP and the distribution address AVP are used when notifying the LAN address that will be used by the next-hop router and the address distributed in the LAN to the next-hop router. The LAN address can be a common address for all CE routers. If a common address is used, the closest CE router responds to the ARP or NDP. A SCCRP that includes the AVP created by CE router A 101 is created and sent to CE router B 102 (step 811). After sending the SCCRP, CE router A 101 remains in standby until it receives the Start-Control-Control-Connection-Connected (SCCCN) message (step 812). CE router A 101, which received the SCCCN message will then establish a control connection (step 813) and will terminate the control connection setup program 312.

CE router B 102 receives the SCCRQ response message (step 903) and then analyzes this message. CE router B 102 determines whether the message is StopCCN (step 904). If it is a StopCCN message, the control connection setup program is terminated. If it is not a StopCCN message, it then determines whether the message is a SCCRP (step 905). If it is not an SCCRP, CE router B102 remains in standby until it receives the SCCRP. After CE router B 102 receives the SCCRP, it then analyzes the AVP that is given to the message (step 906). The distribution IP address that is acquired from the distribution address range or the distribution address AVP, the router ID, IP address, and the distribution IP address are set in the distribution address management table 308 (step 907). In addition, the router ID, notified MAC address, IP address, and the VPN address are set in the connected CE router management table 309 (step 908). Then, the control connection is established (step 909), the SCCN is sent to CE router A 101 (step 910), and the control connection setup program is terminated.

After the control connection is established, CE router A 101 and CE router B 102 start up the session initiation program 313. The session initiation program 313 exchanges messages such as Incoming-Call-Request (ICPQ), Incoming-Call-Reply (ICRP), and Incoming-Call-Connected (ICCN) messages, and then establishes the VPN.

As a result of the above programs, it becomes possible for CE router A 101 and CE router B 102 to distribute uniform addresses for LANs A and B. CE router B 102 acquires addresses that will be distributed to the LAN from the delegate CE router A 101 and holds the distributed addresses in its memory. Even if the VPN connection with delegate CE router A 101 is disconnected, it is possible to distribute the addresses using the LAN that belongs to the CE routers.

The terminal of each CE router (from 103 to 108) acquires addresses using DHCP when each terminal's power is turned ON. DHCP Discover and DHCP Offer messages are used to detect the DHCP server. A DHCP server function is included in CE router A 101 and CE router B 102. DHCP Request and DHCP ACK messages are used for distributing addresses to each terminal and for confirmation.

Communication between terminal A-1 104 on LAN A 203 and terminal B-1 107 on LAN B 204, and between terminal A-1 104 and server C 109 on the internet after a VPN has been established will be explained using FIGS. 1 and 2.

LAN connection information including the IP address, default router, and the DNS is distributed from CE router A 101 to terminal A-1 104 when terminal A-1 104 is connected to LAN A 203. Terminal A-1 104 sets the distributed information. CE router A 101 specifies the own IP address in the default router and the DNS so that CE router A 101 is set as the default router in terminal A-1 104 and the DNS.

Terminal A-1 104 resolves the MAC address of terminal B-1 107, which is the other communicating party, by using the ARP Request and ARP Reply messages.

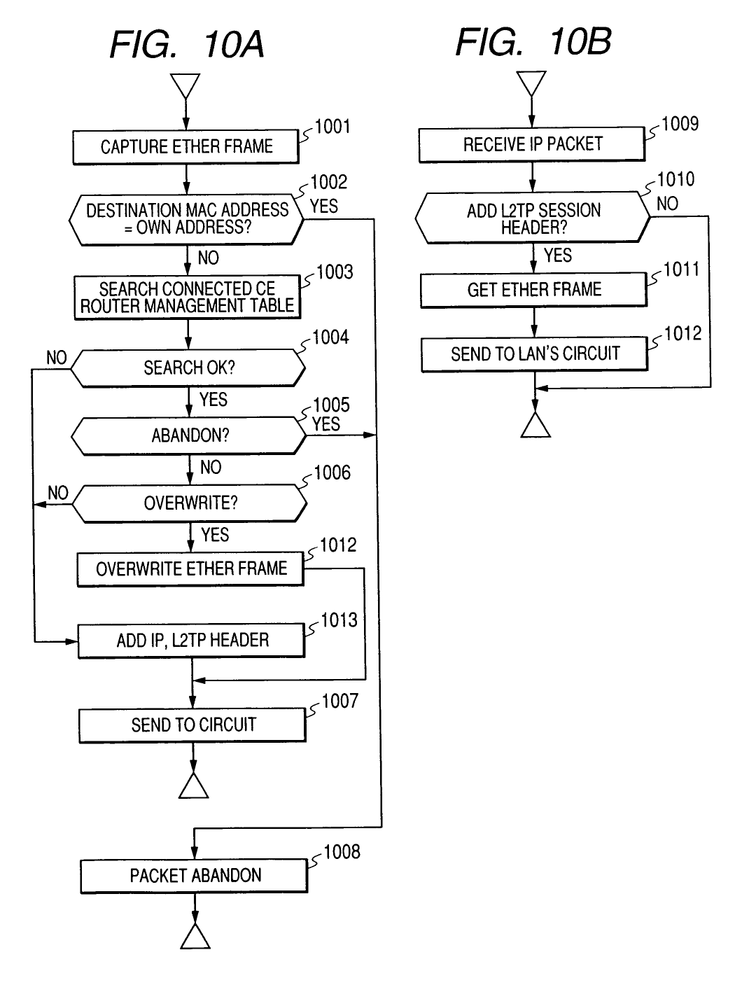

When terminal A-1 104 communicates with terminal B-1 107 in LAN B 204, terminal A-1 104 sends an ARP Request message on LAN A 203 in order to resolve the MAC address of terminal B-1 107. FIG. 10A shows the program flow of the VPN transport program (sender side). The ether frame that is sent on LAN A 203 is captured by CE router A 101 (step 1001). By referencing the router information management table 311, it can be determined whether or not the destination MAC address of the captured ether frame is being sent to the own address (step 1002). If the ether frame destination is the own address, the captured ether frame is abandoned and the program is terminated (step 1008). If it is not being sent to the own address, by referencing the connected CE router management table 309 it can be determined whether or not the destination MAC address of the ether frame is the MAC address of the CE router connected by the VPN (step 1003). If the destination MAC address of the ether frame matches with the MAC address of the CE router connected by the VPN (step 1004), the connected CE router program management table 317 is referenced. If the table value is “Abandon” (step 1005), the ether frame is abandoned (step 1008) and the program is terminated. If the table value is “Overwrite” (step 1006), the ether frame is overwritten (step 1012), output to the LAN circuit (step 1007), and the program is then terminated.

If the destination MAC address of the ether frame does not match with the MAC address of the CE router connected by the VPN, the L2TP header and the IP header are given to the captured ether frame (step 1013). The IP packet created in step 1013 is output to the circuit and the program is terminated (step 1007).

The destination MAC address of the ARP Request message is the broadcast address. Therefore, it is not sent to the own address (step 1002). Also, the destination MAC address of the ARP Request message does not match with the MAC address of the CE router that is connected by the VPN (steps 1003 and 1004), so the L2TP header and the IP header are given (step 1013), and it is output to the circuit that connects with the carrier network (step 1007).

FIG. 10B is a program flow of the VPN transport program (receiver side). CE router B 102 receives the IP packet, confirms the IP payload, and confirms whether or not the L2PT header has been given (step 1009 and 1010). If the L2TP header has not been given, the program is terminated. If the L2TP header has been given, the capsulated ether frame is acquired by the L2TP header (step 1011). The acquired ether frames is then output to the LAN circuit of CE router B 102 (step 1012) and the program is terminated.

The ARP Request message that is output to LAN B 204 is received by all terminals on LAN B 204 (terminals B-1, B-2, and B-3). Terminals that receive the ARP Request message confirm whether or not the address that requests the resolution is the address given to the own interface. If it is the address given to the own interface, an ARP Reply message is sent.

The destination MAC address of the ARP Reply message is the address of the terminal that sends the ARP Request. Therefore, it is not the own address (step 1002) and it does not match with the CE router MAC address connected by the VPN (steps 1003 and 1004). As a result, the L2TP header and the IP header are given (step 1013) and it is output to the circuit connected with the carrier network (step 1007).

CE router A 102 receives the IP packet from the circuit that connects with the carrier network, executes the VPN transport program 314, and outputs the ARP Reply message to the LAN circuit.

Based on the above, terminal A-1 104 resolves the MAC address of terminal B-1 107.

Terminal A-1 104 that resolved the MAC address of terminal B-1 107 capsules the IP packet, which has terminal B-1 107 as the destination IP address, by using the ether frame with terminal B-1 107 as the destination MAC address, and then sends the IP packet on LAN A 203. The ether frame that has been sent on LAN A 203 is processed by the VPN transport program 314 of CE router A 101. As for this ether frame, the destination MAC address is not the own address (step 1002), and it does not match with the CE router MAC address connected by the VPN (steps 1003 and 1004). As a result, the L2TP header and the IP header are given (step 1013) and it is output to the circuit connected with the carrier network (step 1007).

CE router B 102 receives the IP packet from the circuit that is connected with the carrier network, executes the VPN transport program 314, and then outputs the ether frame to the LAN circuit.

Based on the above, terminal A-1 104 and terminal B-1 107 can communicate by connecting through L2.

If terminal A-1 104 communicates with server C 109 on the internet, CE router A 101 is distributed so that the default router of terminal A 101 can capsulate the IP packet, which has server C 109 as the destination IP address, using the ether frame, which has CE router A 101 as the destination MAC address, and then sends it on LAN A 203. The destination of the ether frame that was sent is CE router A 101, so the ether frame is processed by the IP transport program 315. After this, the ether frame is routed from the carrier network 205 to ISP A 206, to the internet 208, and to server C 109 according to the IP routing. As a result, terminal A-1 104 and server C 109 can communicate.

On the other hand, when terminal A-1 104 is connected with LAN A 203 and LAN connection information is not distributed from CE router A 101, it is necessary to set a default route manually in terminal A-1 104. LAN A 203 and LAN B 204 are connected through the L2VPN, so even if CE router A 101 or CE router B 102 is set as the default route, it is possible to communicate with server C 109. However, if CE router B 102 is set as the default route, there will be a large amount of traffic because it has to travel through the VPN. It will be explained how the present invention can prevent taking this long route. In this embodiment, the value of the connected CE router management is set as “Overwrite.”

Terminal A-1 104, which has CE router B 102 as its default route, sends the IP packet to server C 109. The ether frame that was sent by terminal A-1 104 is captured by CE router A 101 (step 1001). By referencing the router information management table 311, it can be determined whether or not the destination MAC address of the captured ether frame is being sent to the own address (step 1002). If the ether frame destination is the own address, the captured ether frame is abandoned and the program is terminated (step 1008). If it is not being sent to the own address, by referencing the connected CE router management table 309 it can be determined whether or not the destination MAC address of the ether frame is the MAC address of the CE router connected by the VPN (step 1003). If the destination MAC address of the ether frame matches with the MAC address of the CE router connected by the VPN (step 1004), the connected CE router program management table 317 is referenced. If the table value is “Abandon” (step 1005), the ether frame is abandoned (step 1007) and the program is terminated. In this embodiment, the table value is “Overwrite” (step 1006), so the destination MAC address of the ether frame is overwritten with the MAC address of CE router A 101 (step 1012). It is then output using the circuit that connects with LAN A 203. The output ether frame is received by CE router A 101 again and is output to the circuit after it is processed by the IP transport program 315. The output IP packet is transferred to the carrier network 205, ISP A network 206, and to the internet 208 according to the IP routing, making it possible to communicate with server C 109.

Based on the above, even if the default route setting of terminal A-1 104 is incorrect, it is possible to communicate with server C 109 through the proper route.

### Second Embodiment

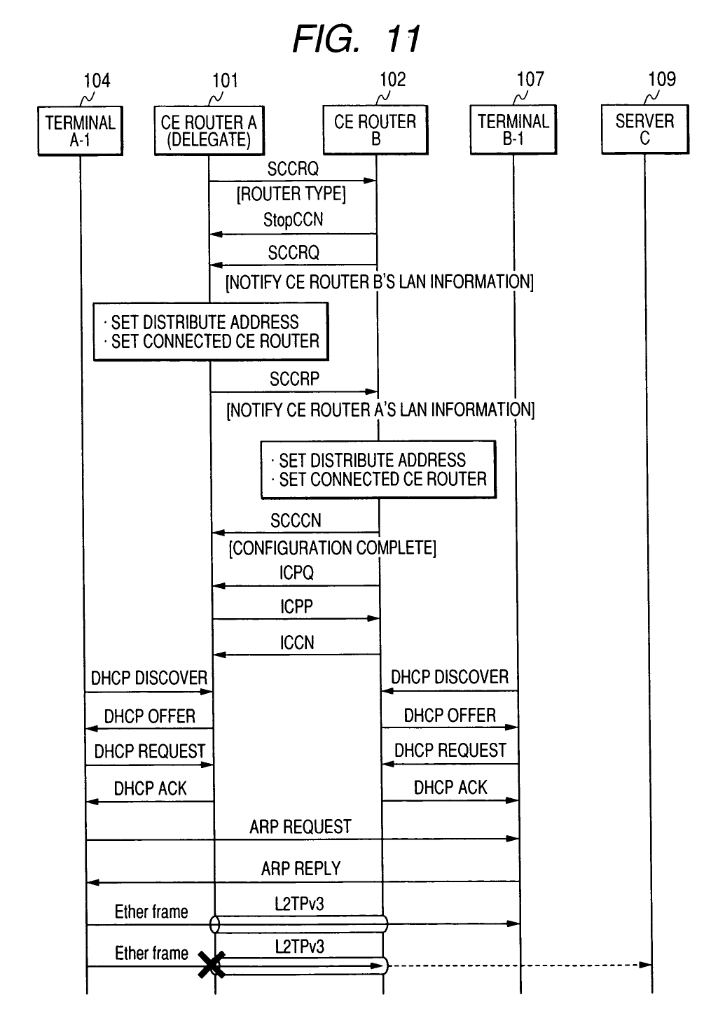

The second embodiment of the present invention explains how to promote the establishment of the control connection from the delegate CE router. FIG. 11 illustrates the sequence that promotes the establishment of the control connection from CE router A 101 (delegate) to next-hop router B 102. The communication system that implements the present invention and the setting conditions for each table are the same as with the first embodiment.

FIG. 8B illustrates the flow of the control connection setup program 312 of the delegate router. FIG. 9B illustrates the flow of the control connection setup program for other non-delegate routers.

CE router A 101 creates an AVP in order to promote the establishment of the control connection for the next-hop router (step 814). In addition to the normal AVP for establishing the control connection, an AVP for each router type is also created. The created AVPs are given to the SCCRQ message and the SCCRQ is then sent to CE router B 102 (step 815). After it sends the SCCRQ, CE router A 101 remains in standby until it receives the response message

CE router B 102 receives the SCCRQ message (step 911) and then analyzes the AVP (step 912). If the AVP router type is set as the delegate router, it is determined that a control connection setup is being requested from delegate CE router A 101. A StopCCN is then sent and the program is terminated (steps 913 and 914). After sending the StopCCN, CE router B 102 executes the control connection setup program, as shown in FIG. 9A. Processes after this are the same as in the first embodiment. CE router A 101 receives the StopCCN and terminates the program. CE router A 101 then remains in standby until it receives the SCCRQ message from CE router B 102.

If the AVP router type is not set as the delegate router, it is determined that a control connection setup is being requested without the distribution address setting. After confirming other AVPs, if the MAC address AVP is set, the connected CE router management table is set (steps 915 and 916). If the MAC address AVP is not set, the connected CE router management table is not set. A control connection is established (step 917), the SCCN is sent (step 918), and the program is terminated.

The VPN transport program 314, which is executed after the VPN is established, is the same as in the first embodiment. Based on the above, it is possible to promote establishment of a VPN from the delegate CE router to non-delegate CE routers. This embodiment is effective when the address pool of the delegate router is changed and the settings of the other CE routers need to be changed.

### Third Embodiment

The third embodiment of the present invention establishes a VPN between CE router A 101 and CE router B 102, and a connection is made with the ISP only from CE router B 102. Terminal A-1 104 on LAN A 203 can communicate with terminal B-1 107 on LAN B 204. An example of a communication interruption between terminal A-1 104 and server C 109 will be explained. It is possible to communicate from terminal B-1 107 to server C 109.

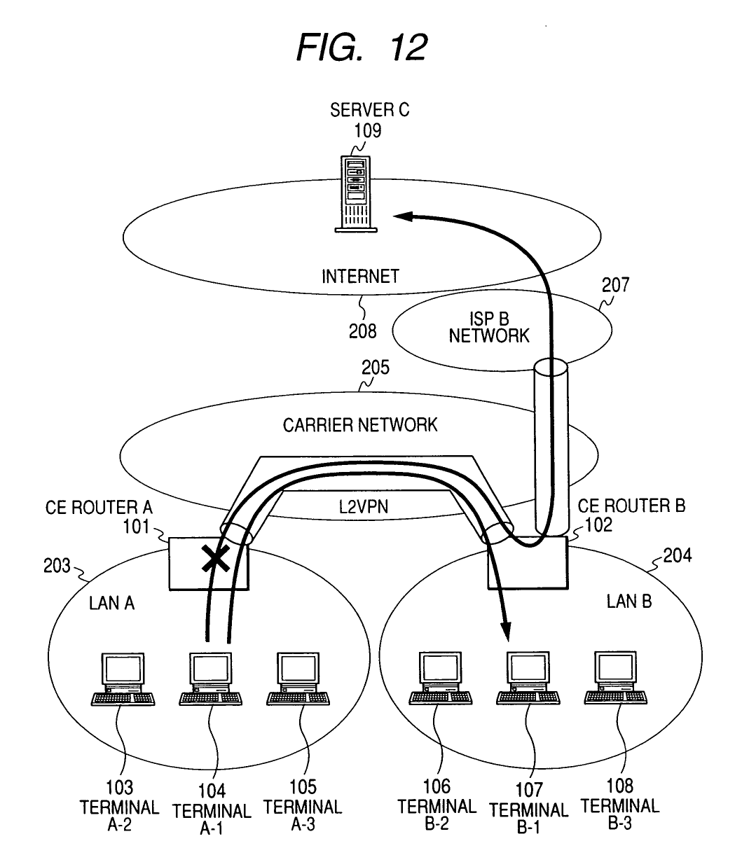

FIG. 12 illustrates a communication system implementing the present invention. This communication system consists of CE router A 101, CE router B 102, LAN A 203 which includes CE router A, LAN B 204 which includes CE router B, the carrier network 205, the ISP B 207, the internet 208, terminal A-1 104 which is included in LAN A, terminal B-1 107 which is included in LAN B, and server C 109 which is included in the internet. CE router A 101, CE router B 102, the carrier network 205, ISP B network 207, and the internet 208 are connected using internet protocol.

CE router A 101 and CE router B 102 execute the same programs as in the first embodiment for establishing the VPN between CE router A 101 and CE router B 102. Communication from terminal A-1 104 to terminal B-1 107 is possible using the same program as in the first embodiment. From here, communication from terminal A-1 104 to server C 109 will be explained. When the default route is CE router A 101 and the packet is sent from terminal A-1 104 to server C 109, the packet is processed by the IP transport program 315. CE router A 101 does not have a route to server C 109, so the server C 109 packet is abandoned.

Also, when the default route is CE router B 102 and the packet is sent from terminal A-1 104 to server C 109, the ether frame sent from terminal A-1 104 is captured by CE router A 101 (step 1001). By referencing the router information management table 311, it can be determined whether the destination MAC address of the captured ether frame has been sent to the own address (step 1002). If the ether frame destination is the own address, the captured ether frame is abandoned and the program is terminated (step 1008). If it is not being sent to the own address, by referencing the connected CE router management table 309 it can be determined whether or not the destination MAC address of the ether frame is the MAC address of the CE router connected by the VPN (step 1003).

If the destination MAC address of the ether frame matches with the MAC address of the CE router connected by the VPN, the connected CE router program management table 317 is referenced. If the table value is “Abandon” (step 1005), the packet is abandoned (step 1008) and the program is terminated. If the table value is “Overwrite” (step 1006), the destination MAC address of the ether frame is overwritten with the MAC address of CE router A 101 (step 1006). It is then output using the circuit that connects with LAN A 203. The output ether frame is received by CE router A 101 again and is processed by the IP transport program 315. CE router A 101 does not have a route to server C 109, so the packet to server C 109 is abandoned.

Based on the above, it is possible to abort communications between terminal A-1 104 and server C 109. This embodiment shows that it is possible to prevent communication from terminals on LAN A, which does not have a communication contract the ISP network, to server C on the internet.

### Fourth Embodiment

The fourth embodiment of the present invention shows an example of a VPN management server 1301 that has been implemented on the carrier network with the IP address of the next-hop CE router being acquired from the VPN management server.

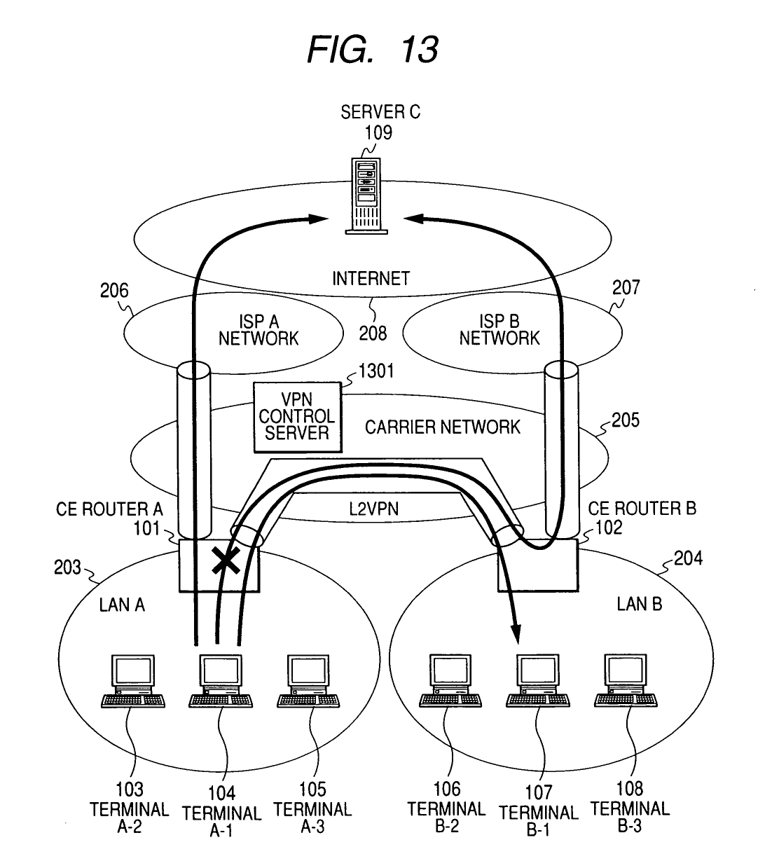

FIG. 13 shows a schematic diagram of a network that has implemented this embodiment. This embodiment is the same as the first embodiment with the addition of a VPN control server 1301 being implemented. The VPN control server manages reachable IP addresses that are registered from the VPN group and the CE router, and manages the router class of each CE router. It is also possible to manage LAN addresses that are used in the VPN group and the setting policies of the connected CE router management table.

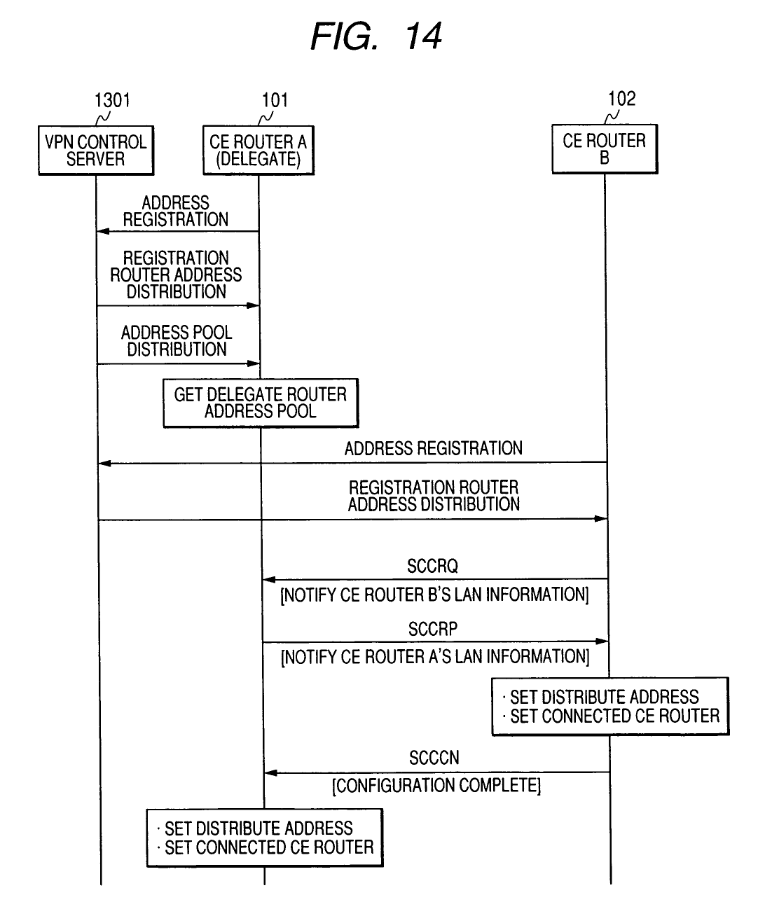

FIG. 14 illustrates a sequence implementing the present invention by acquiring reachable IP address from the VPN control server 1301. CE router A 101 registers the reachable IP addresses from CE router A 101 in the VPN control server 1301. The VPN control server 1301 confirms the VPN group that contains CE router A 101. If the registered CE router already exists, the reachable IP addresses of the registered CE router are distributed to CE router A 101. If the VPN control server manages LAN addresses that are used in the VPN group, the address pool will be distributed to the delegate CE router. When the address pool is distributed, delegate CE router A 101 sets the delegate router address pool table 310.

Afterwards, CE router A 101 executes address registration for the VPN control server 1301. The VPN control server 1301 distributes addresses that are registered in the register CE router. After CE router B 102 receives the distributed addresses, it registers the distributed addresses in the group IP address management table. The control connection setup program 312 is executed for the registered addresses. After this, the processes for establishing the VPN and transporting are the same as with the first embodiment.

Based on the above, it is possible to manage address distribution policies for multiple VPNs.

### Fifth Embodiment

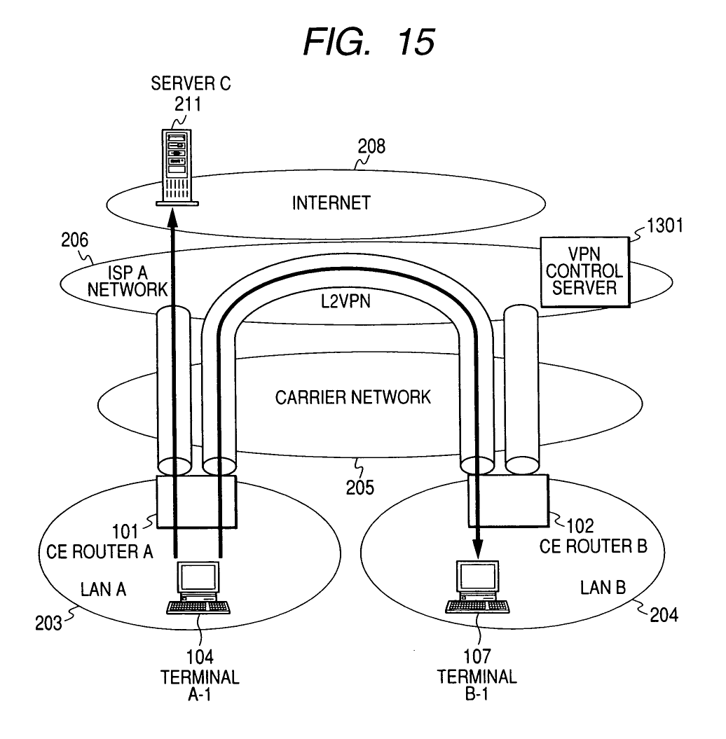

FIG. 15 illustrates a communication system implementing the present invention using an ISP network. This communication system consists of CE router A 101, CE router B 102, LAN A 203 which includes CE router A, LAN B 204 which includes CE router B, the carrier network 205, the ISP A network 206, the internet 208, terminal A-1 104 which is included in LAN A, terminal B-1 107 which is included in LAN B, and server C 109 which is connected to the internet. CE router A 101, CE router B 102, the carrier network 205, ISP A network 206, and the internet 208 are connected using internet protocol and have more than one reachable IP address through the ISP A network 206. This communication system establishes the VPN and transporting the same as with the first, second, third, and fourth embodiments.

Based on the above, even when the ISP provides VPN service, it is possible to provide the same efficiency as the first, second, third, and fourth embodiments.

### Sixth Embodiment

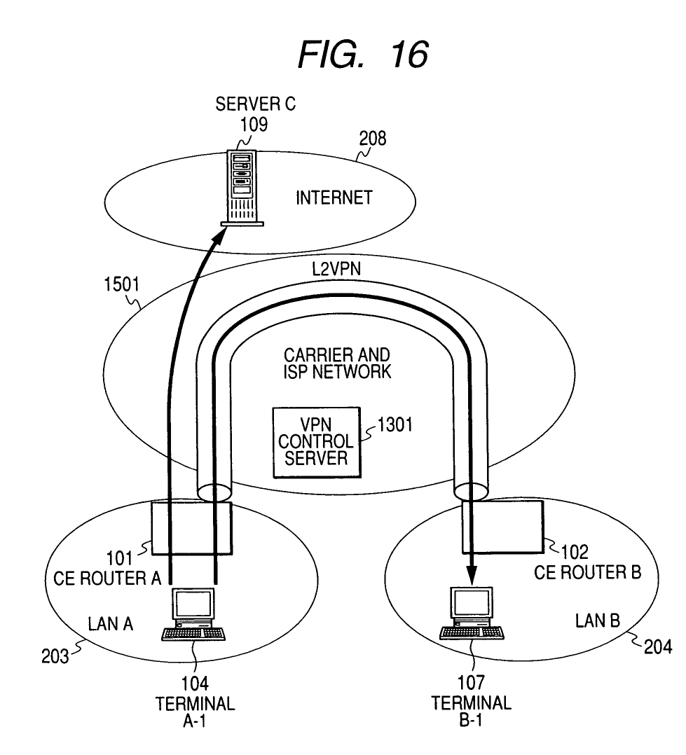

FIG. 16 illustrates a communication system implementing the present invention using a carrier and ISP network. This communication system consists of CE router A 101, CE router B 102, LAN A 203 which includes CE router A, LAN B 204 which includes CE router B, the carrier and ISP network 1501, and the internet 208. CE router A 101, CE router B 102, the carrier and ISP network 1501, and the internet 208 are connected using internet protocol. This communication system establishes the VPN and transporting the same as with the first, second, third, and fourth embodiments.

Based on the above, even when the carrier that includes the carrier and ISP service provides VPN service, it is possible to provide the same efficiency as the first, second, third, and fourth embodiments.

What is claimed is:

1. A router connected to at least one of other routers through a VPN, wherein the router sends and receives setting information or filtering information to and from the one of other routers, the setting information or filtering information being distributed to a network that is included with the router or with the one or more connected routers.

2. The router of claim 1, wherein the setting information has the IP address for the local area network.

3. The router of claim 1, wherein the filtering information has the interface MAC address that connects to the local area network.

4. The router of claim 1, wherein the setting information and filtering information is exchanged between the router and the one of other routers after establishment of a VPN.

5. The router of claim 1, wherein L2TP is used for establishment of the VPN.

6. A communication system comprising: a plurality of routers, wherein the plural routers connect through a VPN, one of the routers holding information that is distributed to the local area network including other routers, with information being sent to other routers.

7. A communication system comprising: a plurality of routers, wherein one router of the plural routers sends its interface information to other routers, the other routers abandoning or canceling the communicated data based on the interface information, or changing the destination address.
